(19) United States
(12) Patent Application Publication
(10) Pub. No.: US 2010/0230546 A1
(43) Pub. Date: Sep. 16, 2010

(54) CONTROL SYSTEM AND CONTROL METHOD FOR AIRBORNE FLIGHT

(76) Inventors: Joeben Bevirt, Santa Cruz, CA (US); Jeffrey K. Gibboney, Menlo Park, CA (US); Giles M. Biddison, Santa Cruz, CA (US); David D. Craig, Santa Cruz, CA (US); Allen Harris Ibara, San Carlos, CA (US)

Correspondence Address: MICHAEL A. GUTH, 2-2905 EAST CLIFF DRIVE, SANTA CRUZ, CA, 95062, US

(21) Appl. No.: 12/566,675

(22) Filed: Sep. 25, 2009

Related U.S. Application Data
(60) Provisional application No. 61/194,989, filed on Oct. 1, 2008.
(60) Provisional application No. 61/205,506, filed on Jan. 20, 2009.

(51) Int. Cl. B64C 31/06; G05D 1/00

(52) U.S. Cl. 244/175; 244/153 R; 244/75.1

(57) ABSTRACT

A control system and method for control of a cyclical flying system which uses lift segments, which may be airfoils, which rotate around a central hub, similar to the mechanics of an autogyro. The airfoils may achieve speeds significantly above the wind speed feeding the system. The airfoils may be linked to the central hub by flexible radial tethers which stiffen considerably as the speed of the airfoil increases. The central hub may be linked to the ground with an extendible main tether. Power generation turbines may reside on the airfoils and utilize the high apparent wind speed for power generation. The generated power may travel down the radial tethers and across a rotating power conduit to the main tether and to the ground. The airborne assembly may have the rotational speed of the airfoils, its altitude, and its attitude controlled by using control surfaces linked to the airfoils, or by control of the angle of attack of the airfoils relative to a central hub, or relative to each other. The attitude and altitude sensors and the control system may be airborne and may be part of the rotating assembly. The airborne assembly can be moved to areas of appropriate wind speed for the system using these controls.

### CROSS-REFERENCE TO RELATED APPLICATIONS

This application claims priority to U.S. Provisional Patent Application 61/194,989 to Bevirt et al., filed Oct. 1, 2008, which is hereby incorporated by reference in its entirety. This application claims priority to U.S. Provisional Patent Application 61/205,506 to Bevirt et al., filed Jan. 20, 2009, which is hereby incorporated by reference in its entirety.

### BACKGROUND

1. Field of the Invention

This invention relates to the control of flying systems, and more specifically to control of an airborne wind-based flying system.

2. Description of Related Art

Wind turbines for producing power are typically tower mounted and utilize two or three blades cantilevered out from a central shaft which drives a generator, usually requiring step up gearing due to the low rotational speed of the blades. Although some airborne windmills are known in the art, they tend towards suspending an apparatus similar to that which would be tower mounted with a balloon or other lift device. An example of a balloon supported device is seen in U.S. Pat. No. 4,073,516, to Kling, which discloses a tethered wind driven floating power plant.

Another aspect of tethered power generation involves a tether, or load cable, linking an airborne airfoil to a mechanical power generation means on the ground. An example of such a device is seen in U.S. Patent Application Publication No. US2007/0228738, to Wrage et al., disclosing a parachute flying in the air and transmitting mechanical force to the ground.

### SUMMARY

A control system and method for control of a cyclical flying system which uses lift segments, which may be airfoils, which rotate around a central hub, similar to the mechanics of an autogyro. The airfoils may achieve speeds significantly above the wind speed feeding the system. The airfoils may be linked to the central hub by flexible radial tethers which stiffen considerably as the speed of the airfoil increases. The central hub may be linked to the ground with an extendible main tether.

Power generation turbines may reside on the airfoils and utilize the high apparent wind speed for power generation. The generated power may travel down the radial tethers and across a rotating power conduit to the main tether and to the ground.

The airborne assembly may have the rotational speed of the airfoils, its altitude, and its attitude controlled by using control surfaces linked to the airfoils, or by control of the angle of attack of the airfoils relative to a central hub, or relative to each other. The attitude and altitude sensors and the control system may be airborne and may be part of the rotating assembly. The airborne assembly can be moved to areas of appropriate wind speed for the system using these controls.

An airborne system for power generation using airfoils or blades which are linked to a central rotor hub and rotate using autorotation, similar to the mechanics of an autogyro. Power generation turbines may reside on the blades and utilize the high apparent wind speed for power generation with little or no need for gearing between the generator blades and the generator.

### BRIEF DESCRIPTION OF THE DRAWINGS

FIG. 1 is a sketch of a centrifugally stiffened cyclically controlled system according to some embodiments of the present invention.

FIG. 2 is a sketch of the rotation portion of a centrifugally stiffened cyclically controlled system with two airfoils according to some embodiments of the present invention.

FIG. 3 is an illustrative sketch of different operation aspects of a centrifugally stiffened cyclically controlled system according to some embodiments of the present invention.

FIG. 4 is a sketch of a centrifugally stiffened cyclically controlled power generation system showing rotational and lift directions according to some embodiments of the present invention.

FIG. 5 is sketch of a centrifugally stiffened cyclically controlled power generation system illustration differential airflows according to some embodiments of the present invention.

FIG. 6 is a sketch of an airfoil with a tail section including a housed turbine according to some embodiments of the present invention.

FIG. 7 is a sketch of an airfoil with a tail section including an unhoused turbine according to some embodiments of the present invention.

FIG. 8 is a sketch of a flying wing including a housed turbine according to some embodiments of the present invention.

FIG. 9 is a sketch illustrating the air velocities over rotating airfoils.

FIG. 10 is a sketch of the rotation portion of a cyclically controlled system with two airfoils rigidly linked according to some embodiments of the present invention.

FIG. 11 is a sketch of a rigid rotation portion of a cyclically controlled power generation system according to some embodiments of the present invention.

FIG. 12 is a sketch of a cyclically controlled system with two airfoils rigidly linked according to some embodiments of the present invention.

FIG. 13 is a sketch of a cyclically controlled power generation system with two airfoils rigidly linked according to some embodiments of the present invention.

FIG. 14 is a sketch of a cyclically controlled power generation system with rigid rotor blades according to some embodiments of the present invention.

FIG. 15 is a sketch of a flying system illustrating some controlled parameters according to some embodiments of the present invention.

FIG. 16 is a sketch of a flying system illustrating some controlled parameters according to some embodiments of the present invention.

FIG. 17 is a sketch of portions of a flying system according to some embodiments of the present invention.

FIG. 18 is a sketch of portions of a flying system according to some embodiments of the present invention.

FIG. 19 is a sketch of portions of a flying system according to some embodiments of the present invention.

FIG. 20 is a sketch of airfoil pitch angles at different positions along the rotation disc according to some embodiments of the present invention.

FIG. 21 is a graph of the heading of the flying system according to some embodiments of the present invention.

FIG. 22 illustrates the flying system according to some embodiments of the present invention at different headings.

FIG. 23 is a graph illustrating desired pitch angle at different headings according to some embodiments of the present invention.

FIG. 24 illustrates aspects of a rotor hub and equipment according to some embodiments of the present invention.

FIG. 25 illustrates a docking system according to some embodiments of the present invention.

### DETAILED DESCRIPTION

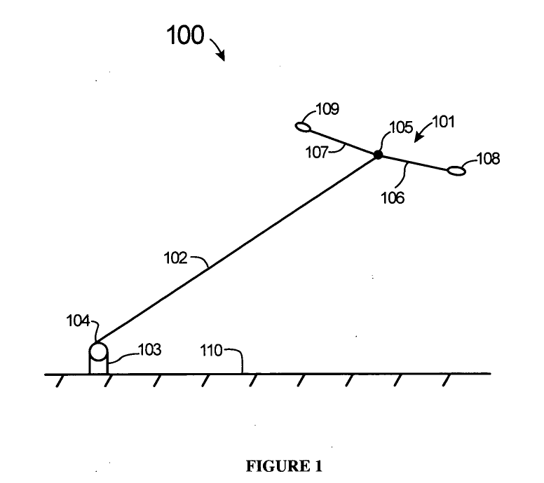

In some embodiments of the present invention, as seen in FIG. 1, a centrifugally stiffened cyclically controlled airborne system 100 has a rotating portion 101 attached by a main tether 102 to a base unit 103. The rotating portion 101 may have a first radial link 106 linking a first controlled lift section, or airfoil, 108 to a central hub 105. A second radial link 107 links a second controlled airfoil 109 to the central hub 105. The central hub 105 is attached to the outboard end of a main tether 102 which is extended from an extension unit 104 on a main base unit 103. The main base unit resides upon the ground 110, although it may reside upon a floating platform or other anchoring system in some embodiments.

The system is adapted to allow the airfoils engage in autorotation. In a traditional autogyro, the rotating airfoils are propelled through the air with the use of an engine and propeller. The forward motion of the autogyro machine (once the rotating airfoils have been initiated into rotation) furthers autorotation of the rotating airfoils, which in turn provide lift for the autogyro machine. Flying autogyro machines sometimes appear to the eye to be a combination airplane and helicopter, but typically the rotating airfoils are not powered.

In some embodiments of the present invention, the rotating airfoils provide lift similar to the rotating airfoils of an autogyro machine, but are tethered in position in a prevailing wind, and it is this wind that encourages and continues the autorotation of the rotating airfoils.

In some embodiments, the main tether 102 is adapted to be let out from an extension unit 104 which may include a rotating drum unit adapted to rotate to extend or withdraw the tether. In some embodiments, the bulk of the length of the unextended portion of the tether may be stored separately from the rotating drum unit, allowing the drum unit to be smaller in size and allowing the radius of rotation of the drum unit and tether at the point where the tether is being extended to be the same radius at all times. In some embodiments, the main tether 102 is flexible and adapted to be wound around a drum.

The rotating assembly 101 is adapted to rotate in a plane at an angle to the main tether 102. In some embodiments, the rotating assembly 101 is allowed to rotate substantially circularly around the main tether 102 without twisting the tether due to a rotational coupling at the central hub 105. The rotational coupling may utilize mechanical bearings, magnetic bearings, or other means.

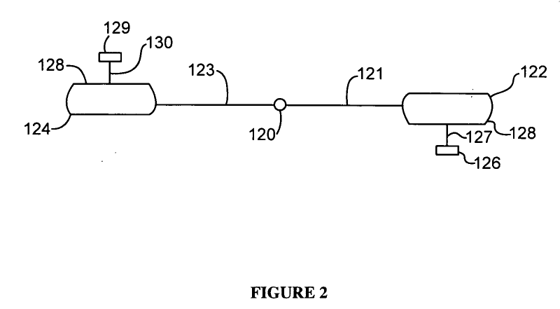

In some embodiments, as seen in FIG. 2, the rotating assembly consists of two controllable lift sections, or airfoils. A first airfoil 125 is attached to the rotor hub 120 by a first radial link 121. The first airfoil 125 may consist of a wing 122, a tail structure 127, and a tail 126. In some embodiments, the tail 126 includes a controllable elevator which allows for control of the angle of attack of the wing 122. A second airfoil 124 is attached to the rotor hub 120 by a second radial link 123. The second airfoil may consist of a wing 128, a tail structure 130, and a tail 129. The tail may include a controllable elevator which allows for control of the angle of attack of the wing 128. In some embodiments, the airfoils may have other controllable surfaces, including rudder function, ailerons, and flaps.

In some embodiments, the radial links are flexible tethers. The rotating assembly is adapted such that the airfoils generate forward motion relative to the airfoil wing, and are constrained laterally by the radial tethers. This constraint results in a predominantly circular flight path by the airfoil around the rotor hub. As the speed of the airfoils increases, the centrifugal forces result in higher loads in the radial tethers. As the tension increases in the radial tethers, the stiffness of the system increases. As the airfoils engage in their circular flight, they are able to achieve rotational speeds which result in air speed over the wing of the airfoil that is significantly higher than the exterior, ambient wind speed. The controllable aspect of the airfoil, for example the elevator control, allows the angle of attack of the wing of the airfoil to be adjusted, which gives control over the rotational velocity of the airfoils and of the entire rotating assembly, of which the airfoils are a part.

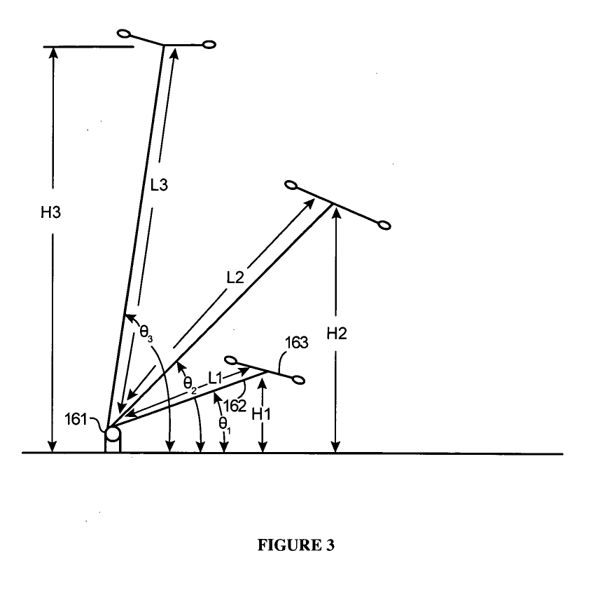

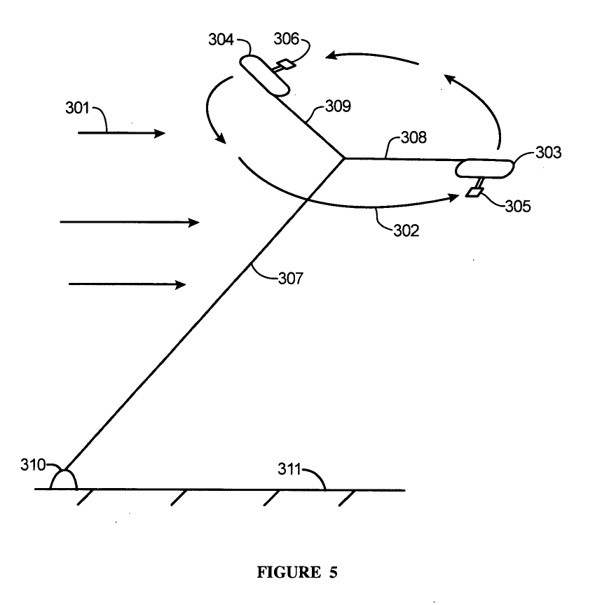

FIGS. 3 and 5 illustrate some aspects of the cyclically controlled system according to some embodiments of the present invention. As seen in FIG. 3, a main tether 162 anchored to a base unit 161, and its rotating assembly 163, may be used in a variety of altitudinal (ie barometric), positional (ie gps, augmented gps) and attitudinal scenarios. The system may be flown at different altitudes for different reasons. In some cases, a boundary layer may prevent prevailing wind of sufficient strength or consistency from occurring near the ground. In such a case, the system may need to be flown above the boundary layer. In another case, the system may seek to fly in much higher altitude winds, such as seen with a jet stream. In other cases, the system may need to be raised or lowered to avoid winds which are too high or too low, or to avoid weather features, or for other reasons. In some embodiments, the system may include interactivity with a wind monitoring system which is adapted to look upwind and determine coming windspeeds. The wind monitoring system may be able to sense windspeed many miles into the upwind direction, and differentiate windspeed based upon altitude as well. The cyclically controlled system may be raised and lowered in altitude based upon the input from this wind monitoring system.

In a first scenario, the main tether has been reeled out for a total length L1 at an angle relative to the ground of Θ1, resulting in a height H1 of the central hub. It is understood that with a flexible tether that the main tether is not truly linear, and Θ1 may be understood to be the angle between the base unit and the rotor hub. This low angle of incidence may be seen shortly after takeoff of the airfoils, or may be lower than actually seen in normal flight scenarios, and is used in illustrative example.

In a second scenario, the main tether has been reeled out for a total length L2 at an angle relative to the ground of Θ2, resulting in a height H2 of the central hub. This may be exemplary of a scenario wherein a system flies above a near ground boundary layer.

In a third scenario, the main tether has been reeled out for a total length L3 at an angle relative to the ground of Θ3, resulting in a height H3 of the central hub. This may be exemplary of scenario wherein the system has been raised up into the jet stream.

In some embodiments, the system may be moved from one altitude to another, or one angle of incidence of the main tether Θ to another, using a control system controlling the airfoils on the outboard ends of the radial tethers.

FIG. 5 illustrates a system flying in an ambient wind velocity V1 at the altitude of the rotating assembly. The rotating assembly is seen flying with a rotational velocity w1. The individual airfoils 303, 304 are attached to a rotating hub with tethers 308, 309 of a length r1. The velocity of the airfoils is r1*w1. The apparent windspeed over the airfoils will differ depending upon which portion of the circular flight path 302 they are in. For example, a first airfoil 304 heading into the ambient wind will have the ambient wind speed added to the velocity due to rotation to arrive at the windspeed over the airfoil. A second airfoil 303 heading away from the ambient wind direction will have the ambient wind speed subtracted from the velocity due to rotation to arrive at the windspeed over the airfoil.

The differences in the simultaneous windspeeds over the two airfoils will result in different lift and drag from the two airfoils. Thus, without control of the airfoils to counteract this aspect, one portion of the circular flight path 302 will have increased lift and another will have decreased lift. This will take the rotating assembly's plane of rotation off of perpendicular from the main tether, taking the lift vector off of parallel with the main tether and will tend to move the main tether.

Planned movement of the main tether 307, or retention of the main tether in the same position in light of the differential lift aspect mentioned above, may be addressed using a control system which takes into account the cyclical nature of the forces on each airfoil. The first airfoil 303 may have an elevator control surface 305, and the second airfoil 304 may have an elevator control surface 306. Cyclical manipulation of these control surfaces as the airfoils go through a cycle of rotation may be used to do planned movement, or purposeful stabilization, of the main tether, and with it the position of the rotating assembly. For example, in the case of purposeful stabilization and position retention of the main tether and rotation assembly, the elevator control surface of an airfoil can be adjusted in a first direction as the airfoil is coming around the rotation cycle into the ambient wind. The elevator control surface of this airfoil can then be adjusted in a second direction as the airfoil comes around the rotation cycle away from the ambient wind. With such a cyclically controlled system, planned movement or purposeful retention of position can be accomplished.

In some embodiments, the flying system may be used to generate pull along the tether from the rotating portion to the ground unit. The pull may be used to power a generator or other device. The force in tether may be used to pull on a drum which in turn rotates a shaft, providing mechanical input for an electrical generator. The ground unit may then reel back in the tether while the rotating portion has been controlled to generate less force on the tether. The sequence may then be continually repeated. The force on the tether may be increased, when pull is desired, by increasing the collective lift of the airfoils.

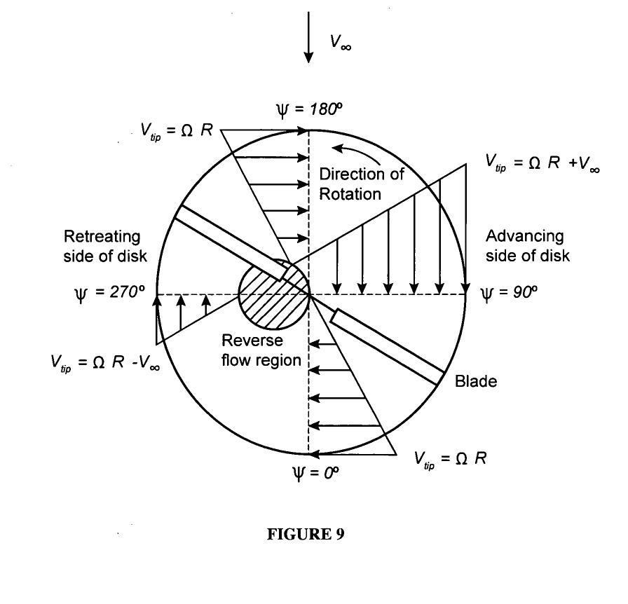

FIG. 9 illustrates the differential wind speed seen in a fixed rotor rotating in an oncoming wind. As seen, there is differential wind speed on a rotor blade or airfoil as it rotates through a cycle. This in turn results in differential lift and drag. In some embodiments of the present invention, the airfoil design may include a twist along the length of the airfoil around an axis parallel to the radial link. This twist along the length of the airfoil takes into consideration the differing airspeeds along the airfoil in the radial direction. In this fashion the design may be similar to the design of a turbine blade, which also takes into consideration different airspeeds at differing radial distances.

In some embodiments of the present invention, the central hub itself may have aerodynamic or airfoil aspects in its design. In some embodiments, the central hub may have control surfaces that enable it to direct motion of the rotor hub in a prevailing wind. In some embodiments, there may be aerodynamic aspects to the rotor hub adapted to stabilize the central, or rotor, hub, whether against buffeting from the prevailing winds, differential pulling from the radial tethers, or for other reasons.

In some embodiments of the present invention, the central hub may have a variety of sensors adapted to be used by a control system controlling the rotating assembly. Altitude sensors, attitude sensors, and wind speed sensors may be mounted on or near the rotor hub. In some embodiments, the air speed over the airfoils may be registered by sensors on the airfoils. Other position, attitude, altitude, and air speed sensors may be mounted in various locations along the system to assist in control of the system.

In some embodiments, most or all of the sensors used in a control system to cyclically control and stabilize the rotating assembly may be mounted on the rotating assembly, and on the non-rotating portion of the rotor hub. In some embodiments, the control system electronics may also be mounted on the rotating assembly, and on the non-rotating portion of the rotor hub.

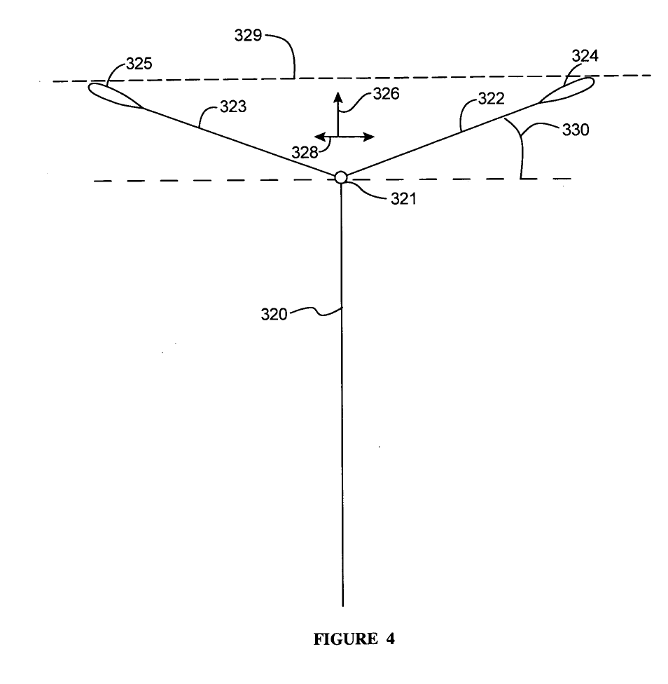

FIG. 4 illustrates aspects of a cyclically controlled centrifugally stiffened system according to some embodiments of the present invention. A main tether 320 is linked to a rotating portion with two airfoils 324, 325. The two airfoils 324, 325 are linked to a rotor hub 321 by flexible radial tethers 322, 323. As the airfoils fly in a wind coming from under the rotating assembly at an angle along the main tether 320, which is dragged downwind from the main base by the ambient wind, the lift of the airfoils tends to raise the airfoils in a direction 326 somewhat parallel to the main tether 320. As the airfoils are constrained by the radial tethers, this lift will not raise the airfoil straight along the lift direction, but the airfoils will be moved by forces in this lift direction in an arc swept out with a radius of the length of the radial tether. The tip path plane 329 is seen as the plane within which the airfoils sweep as they rotate. The coning angle 330 is seen as the angle above a hypothetical “flat” plane which would be circumscribed without lift of the airfoils, and which may not be parallel to the ground. The angle between the tip plane path and the ground may be referred to as the angle of incidence “i”.

Rather than being swept up along the lift direction and ending up in a position along a line extended from the main tether, a counterbalancing set of forces comes into play. As the airfoils 324, 325 speed up in their circular and cyclical flight paths, there are centrifugal forces 328 which put forces on the airfoils to move them radially away from the rotor hub. The radially outward forces then also tend to flatten the flight path of the airfoils, reducing the coning angle. Thus, no radial links of stiff material, and no resistance of bending moment at the rotor hub, are needed to keep the airfoils “flattened” in their circular flight paths. The speed of the airfoils can be manipulated to increase the speed and to “flatten” the flight profile.

In some embodiments of the present invention, a control system is adapted to control one or more aspects of the centrifugally stiffened cyclically controlled system. A control system, which may include a processor may, reside fully on the flying hub, fully on the ground, or in part on both the hub and the ground in some aspects, and utilize inputs from airspeed sensors on the airfoils, ambient wind speed sensors on the rotor hub, ambient wind speed sensors remotely located or adapted to read wind speed at a distance, attitude and altitude sensors, and other sensors to determine the values of these parameters related to control of the rotating portion's location, altitude, rotational velocity, and other aspects. The control system may then receive input from an operator, or run pre-determined operational paradigms, and utilize control surfaces on the rotating portion, and extend or retract the main tether, in order to control the system.

In the case of cyclical control, the control system may take into account processing delays, electrical delays, and airfoil control system delays in order to phase shift the commands to control surfaces such that actions occur at the desired time.

Because the airfoils can be controlled to obtain very high rotational velocities, the apparent airspeed over the wings can become very high. This circumstance presents an opportunity to harvest energy from the very high airspeeds obtained as the airfoils obtain these high rotational velocities, even in ambient wind speeds that are much lower. Wind turbine driven electrical power generators, or other types of wind driven power generators, may be integrated into, onto, or near the airfoils to take advantage of the high airspeeds generated by the circular flight paths. In the case of wind turbine driven electrical power generators, electrical power generated at the airfoils may be transferred via conductors along the radial tethers (in the case of flexible tethers), or along the spars (in the case of stiffened spars), through a rotating power conduit at the central hub, and then transferred to the ground via conductors along the main tether.

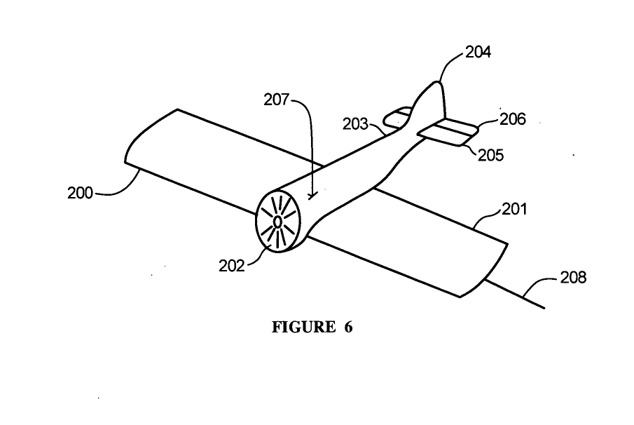

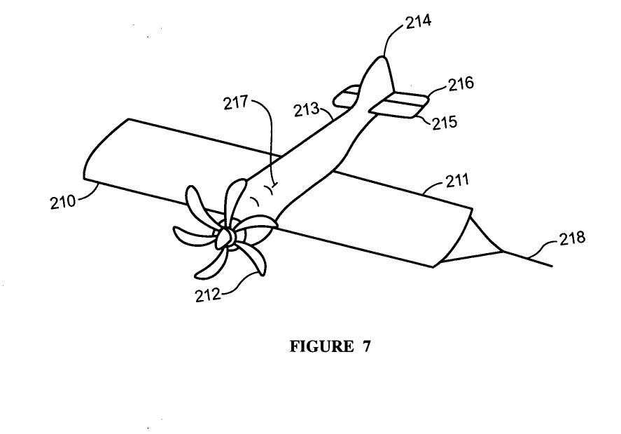

FIGS. 6, 7, and 8 illustrate airfoils with turbine drive generators according to some embodiments of the present invention. In some embodiments of the present invention, as seen in FIG. 7, an airfoil 200 adapted to be flown on the end of a flexible radial link, such as a tether 208, or along a rigid radial link, such as a spar, has a housed turbine drive generator 207 within the airfoil. The wing 201 of the airfoil 200 is radially constrained during its rotational flight path by a radial tether 208. The radial tether 208 may perform a dual function of being a structural attachment to the central hub, as well as an electrical power conduit for the electrical power developed by the power generation turbine. The airfoil 200 may have a tail structure 203 with a vertical stabilizer 203 and a horizontal stabilizer 205. The horizontal stabilizer 205 may have a controllable elevator 206, or other type of elevator control. Although the airfoils are shown with a controllable elevator, in the case of rigid radial links the airfoil angle of attack may be controlled with the use of mechanisms at the rotor hub interface, or at the interface of the airfoil and the rigid radial link.

The rotor blades 202 of the housed turbine drive generator 207 are housed within the structure of the airfoil or an adjoining cowling. Utilizing the high speed airflow available due to the high rotational velocity of the rotating portion of the system, the turbine is able to develop its own high rotation speed and drive an electrical generator. Due to the high speeds attained by the airfoil in its cyclical flight path and the high rotational speeds in the turbine blades 202, the power generator may be able to forego the use of gearing that may otherwise be required with systems operating in lower wind speeds.

With regard to the use of the terms turbine and propeller, it is pointed out that because of the dual use of the powered equipment in some embodiments, both to power the airfoils and to power the rotating flight in some aspects, and to generate electrical power during rotating flight in other aspects, some terminology may need clarification. Typically, a motor drives a propeller to provide power for flight. Also, typically a turbine drives a generator. In the case wherein a motor drives a propeller, but then the same propeller is used as a turbine to provide drive to a generator, as in some embodiments of the present invention, the terminology as described above may be interchanged in describing the same equipment.

In some embodiments of the present invention, as seen in FIG. 7, an lift section 210 adapted to be flown on the end of a radial tether 218 has a turbine drive generator 217 within the airfoil powered by a propeller 212. The wing 211 of the lift section 210 is radially constrained during its rotational flight path by a radial tether 218. The radial tether 218 may perform a dual function of being a structural attachment to the central hub, as well as an electrical power conduit for the electrical power developed by the power generation turbine. The radial tether may be a rigid link, such as a stiffened spar, in some embodiments. In some embodiments, the stiffened spar may have asymmetric vertical and horizontal sections, or may be purposefully stiffened in various ways, to enhance the passive stability of the airfoils and to enhance control of the airfoils. The lift section 210 may have a tail structure 213 with a vertical stabilizer 214 and a horizontal stabilizer 215. The horizontal stabilizer 215 may have a controllable elevator 216, or other type of elevator control.

The turbine/propeller 212 of the turbine drive generator 217 is forward of the structure of the airfoil. Utilizing the high speed airflow available due to the high rotational velocity of the rotating portion of the system, the turbine is able to develop its own high rotation speed and drive an electrical generator. Due to the high speeds attained by the airfoil in its cyclical flight path and the high rotational speeds of the propeller, the generator may be able to forego the use of gearing that may otherwise be required with systems operating in lower wind speeds.

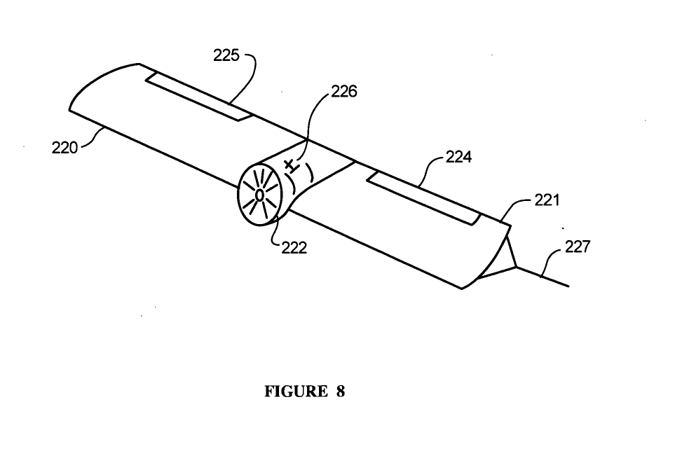

In some embodiments of the present invention, as seen in FIG. 8, a flying wing type airfoil 220 adapted to be flown on the end of a radial tether 227 has a turbine drive generator 226 within the airfoil powered by inlet blades 222. The wing 221 of the airfoil 220 is radially constrained during its rotational flight path by a radial tether 227. The radial tether 227 may perform a dual function of being a structural attachment to the rotor hub, as well as an electrical power conduit for the electrical power developed by the power generation turbine. The airfoil 220 may have ailerons 224, 225 for elevation control to control the angle of attack of the airfoil.

In some embodiments, system may be designed to generate 10 MW. The sweep of the rotating portion may have a diameter of 150-200 meters. The system may be used with a large range of sizes, from smaller systems designed to operate at 0-200 meters altitude, to larger systems designed to operate at altitudes of 50,000 feet or more. Systems which large rotating portions may be used at low altitudes as well as high altitudes. Systems with small rotating portions may be used at low altitudes as well as high altitudes.

In some embodiments of the present invention, drag from the airfoil mounted turbine drive generators may be used as part of the control system of the overall system. For example, drag may be modified by reducing or increasing the electrical load on the generators on the airfoils. Reduced drag may be used during periods where increased speed of the airfoils is desired, and increased drag may be selected for reasons of stability of the system, or for other reasons.

In some embodiments of the present invention, the airfoils with electrical power generation capability may also have the capability of electrically powered flight. For example, instead of using the generator and its blades/propeller as a electrical power generation source, the system is instead used to power the flight of the airfoil. In this type of scenario, electrical power may be supplied via the base unit, travel along the electrical conduit of the main tether, be transferred at the central hub with a rotating power coupling to the radial tethers, and be used to drive the generators, which will function as electric motors. The blades/propeller of the airfoils are then used for propulsion of the airfoil. The powered flight option may be used to maintain the airborne status of the rotating assembly in wind conditions that are not sufficient or suitable for flight of the airfoils. Also, the powered flight option may be used to initiate the flight sequence of the system. The powered flight option may be used to get the airfoils airborne, including the use of vertical take-off scenarios.

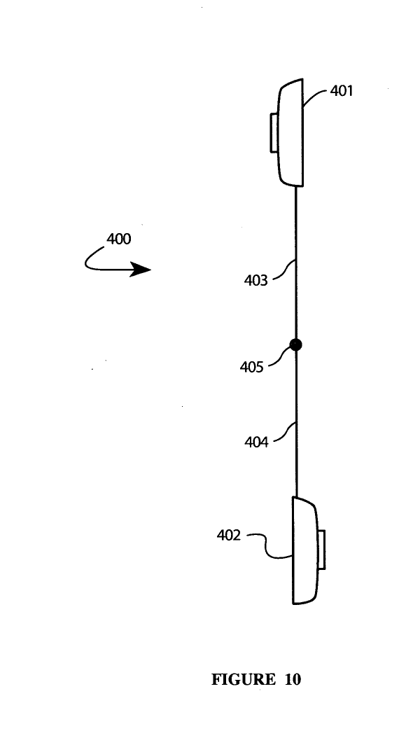

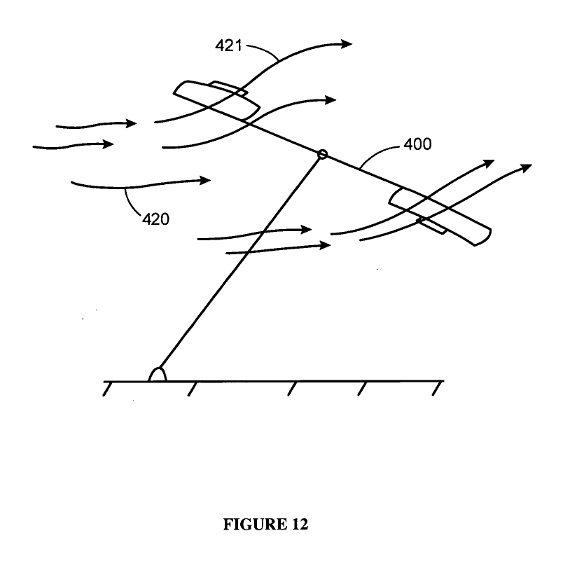

In some embodiments of the present invention, as seen in FIGS. 10-14, the rotating assembly may be substantially rigid, in contrast to the rotating assemblies described above with substantially flexible tethers. In an extended airfoil system embodiment 400 as seen in FIG. 12, airfoils 401, 402 are linked to central hub 405 with rigid radial links 403, 404. As seen in FIG. 12, when in flight the system 400 utilizes the oncoming wind 420, which is deflected upwards 421 through the airfoils. With the rigid radial links, the system 400 appears to operate as an autogyro tethered to the ground.

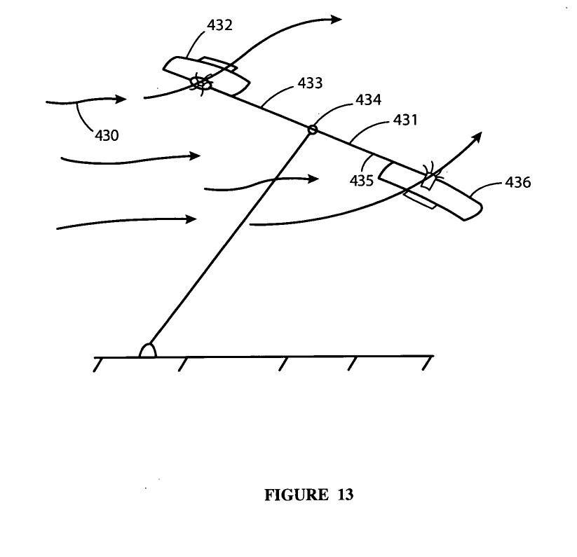

In some embodiments of the present invention, as seen in FIG. 13, an autorotating airfoil system 431 may be adapted for power generation. The airfoils 432, 436 may include turbine drive generators within them which are adapted to generate electrical power. The turbine drive generators may take advantage of the high airflow speeds over the airfoils resulting from the high rotational speeds of the airfoils due to autorotation. The oncoming winds 430 are routed up through the rotational plane of the rotating airfoils. The airfoils 432, 436 may be linked to the central hub 434 with rigid radial links 431, 433.

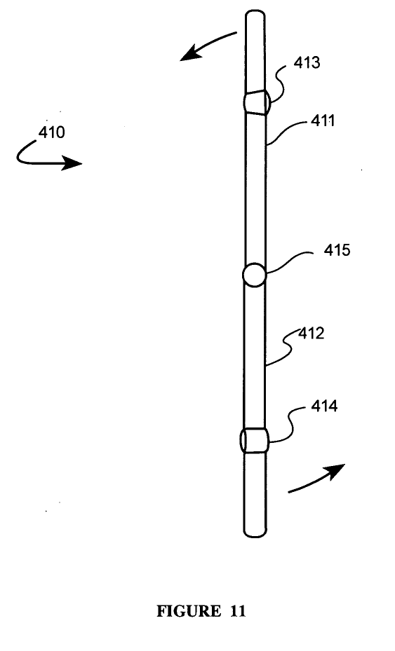

In some embodiments of the present invention, a rotating blade system 410 may be adapted to autorotate and generate electrical energy. In some embodiments of the present invention, as seen in FIG. 11, a rotation portion 410 of a tethered system has a first blade 412 and a second blade 411 coupled to a central hub 415. The blades 411, 412 may have turbine drive generators 413, 414 adapted to translate wind energy in to electrical power. The generators may be smaller and lighter than typical wind powered generators due to the high windspeeds generated over the airfoils during autorotation, which may preclude the need for heavy and bulky gear systems between the turbine and the generator.

In some embodiments, the blades 411, 412 may be linked to the central hub 415 using joints which allow for some motion of the blades relative to the rotor hub. The joints may include spring loaded or otherwise damped radial joints to allow for some motion of the blades along their rotation path relative to the rotor hub. The joints may include spring loaded or otherwise damped joints which allow for some motion of the blades perpendicular to the rotation axis of the blades. In some embodiments, the angle of attack of the blades relative to the rotor hub may be controlled by mechanisms at the junction of the blade with the rotor hub.

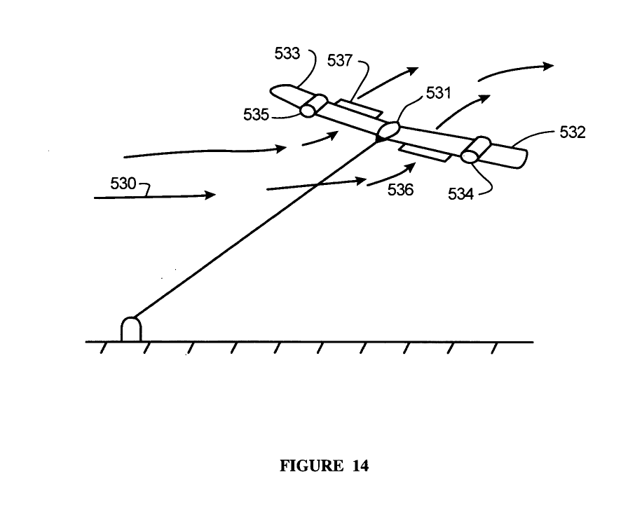

In some embodiments of the present invention, as seen in FIG. 14, a tethered power generation system utilizes an autorotating set of blades with integral turbine drive generators. The blades 532, 533 with their turbine drive generators 534, 535 rotate around a rotor hub 531. The blades may have control surfaces 536, 537 adapted to provide control of the blades to assist in stabilization of the rotating portion, or to raise or lower the rotating portion to different altitudes.

In some embodiments of the present invention, a control system is adapted to control one or more aspects of a rotating blade or rotating airfoil system. A computer or processor may reside on the ground in some aspects, or on the central hub, and utilize inputs from sensors on or near the airfoils, ambient wind speed sensors on the rotor hub, ambient wind speed sensors remotely located or adapted to read wind speed at a distance, attitude and altitude sensors, and other sensors to determine the values of these parameters related to control of the rotating portion's location, altitude, rotational velocity, and other aspects. The control system may then receive input from an operator, or run pre-determined operational paradigms, and utilize control surfaces on the rotating portion, and extend or retract the main tether, in order to control the system.

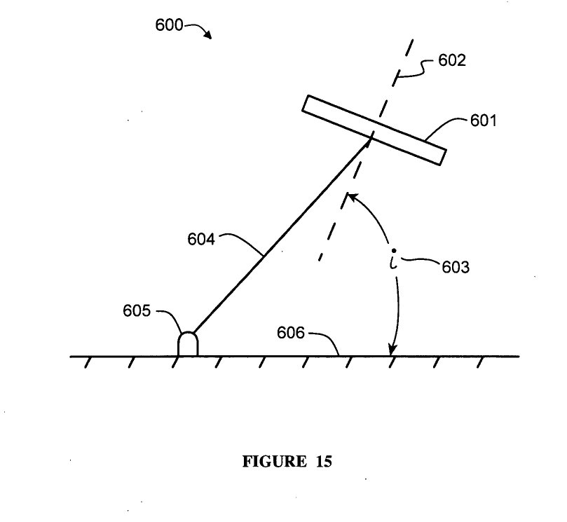

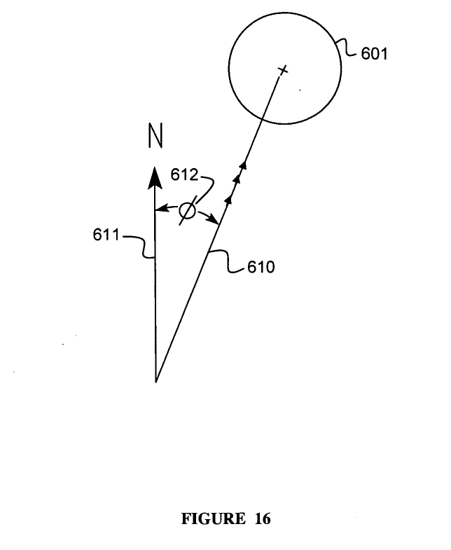

In some embodiments, as seen in FIGS. 15 and 16, the rotating airfoil system 600 is seen with a tether 604 attached to a base unit 605, which may be on the ground 606. In some embodiments, the rotating airfoil system may use two rotating lift sections, such as airfoils or blades, according to previously described embodiments. As the rotating airfoils rotate, which may be autorotation in a prevailing wind, or powered flight, or some combination, as previously described, the lift sections may rotate during stable flight in a rotation envelope 601. In a rigidly linked system, the rotation envelope may be idealized as a planar disc, although in a typical system the flexibilities of the components of the system, and the slight variations from idealized flight paths, will result in an envelope, which will be referred to as the rotation envelope 601.

As seen in FIG. 15, an axis 602 is perpendicular to the rotation envelope 601, which is represented as a disc of some thickness. The angle of inclination 603 of the perpendicular axis to the rotation envelope disc, i, is a parameter that can be used in a control system, and which can be controlled for in a control system for a rotating airfoil system.

As seen in FIG. 16, the perpendicular axis 602 of the rotation envelope 601 has a vertical projection downward to the ground which can be represented as a line 610. Although in some flight paradigms the vertical projection 610 may be aligned with the projection of the tether 604, there is no need for this to be so. The vertical projection downward is defined directionally along the line, and the angle 612 of the vertical projection line 610 to a fixed reference direction 611 is referred to as the heading of the rotation envelope, and referred to herein as ø. The direction of the heading is in the direction outward from the center of the system as seen in FIG. 16. The heading is a parameter that can be used in a control system, and which can be controlled for in a control system for a rotating airfoil system.

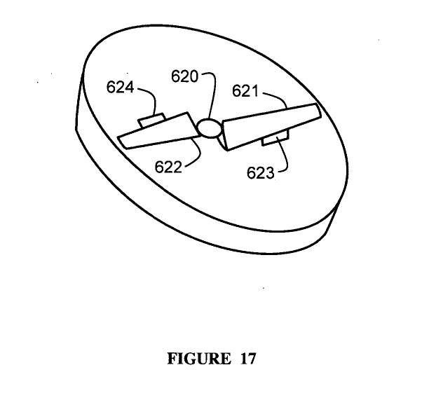

In some embodiments, as seen in FIG. 17, the rotation envelope 601 may have a first airfoil 621 and a second airfoil 622. In some embodiments, the first airfoil 621 and the second airfoil 622 rotate around a central hub 620. In some embodiments, the two airfoils may be 180 degrees offset around the rotor hub. In some embodiments, the two airfoils may be rigidly coupled to each other, with a rotational degree of freedom allowing for motion relative to the angle of attack of the wing. In some embodiments, the first airfoil 621 and the second airfoil 622 may have control surfaces 623, 624 adapted to control the airfoil rotationally along their lengths. In some embodiments, the airfoils may be rotationally controlled at the central hub using actuators.

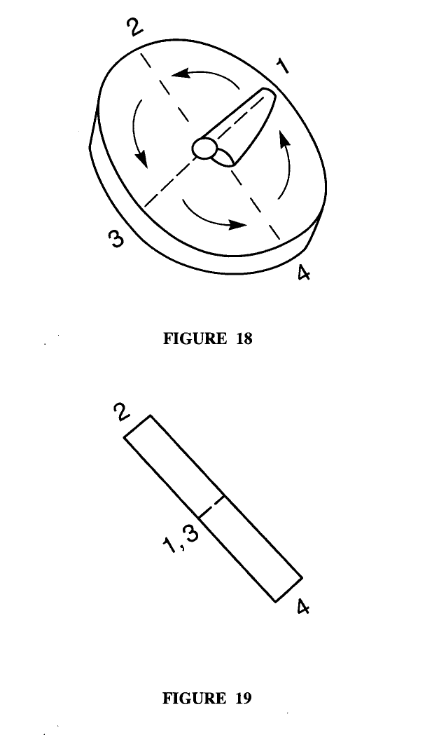

FIGS. 18 and 19 illustrate a rotational cycle of a single airfoil as it rotates around the rotation envelope. Although a single airfoil is seen, it is understood that in typical use two airfoils are used as described above, or in some embodiments a plurality of airfoils are used. In a first position 1, the airfoil is at its steepest upward pitch relative to the ground below, as it is rising in flight through the rotation envelope, which is inclined at the inclination angle i. At a second position 2, the airfoil has reached the highest point in its rotation and, as it is now passing around toward the descending portion of the rotation, is at a neutral, or flat, pitch. At a third position 3, the airfoil is at its steepest downward pitch relative to the ground below, as it is descending in flight through the rotation envelope, which is inclined at the inclination angle i. At a fourth position 4, the airfoil has reached the lowest point in its rotation and, as it is now passing around toward the ascending portion of the rotation, is again at a neutral, or flat, pitch. Although illustrated as a wing type airfoil with its base at the central hub, other embodiments may be used. For example, an airfoil may be at a radial distance removed from the central hub, and attached to the central hub with a rigid link, or spar, in some embodiments. In some embodiments, the airfoil may be at a distance from the rotor hub and include a power generation and propulsion system.

In a stable flying scenario wherein the inclination angle is, for example, 20 degrees, the airfoil will have its pitch at 20 degrees and position 1, at −20 degrees at position 3, and at 0 degrees at positions 2 and 4. The zero degree position may be relative, as it must have sufficient angle of attack, and lift, to keep the mass of the system airborne. Thus, to maintain a stable system at an inclination of 20 degrees, the rotating airfoils could be controlled to maintain their pitch in accord with the just described scenario.

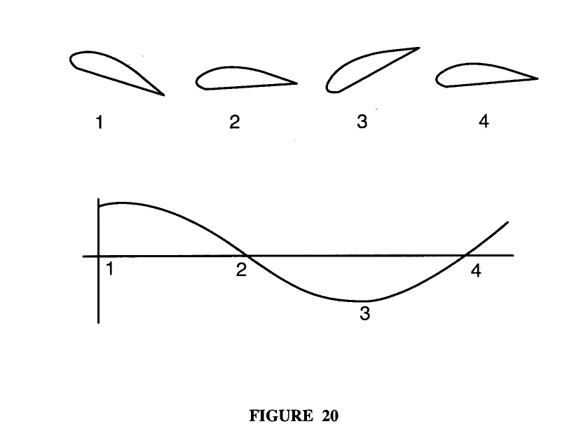

FIG. 20 illustrates the pitch of the airfoil as it rotates around a cycle. The airfoil pitch is shown in profile for positions 1-4, and graphically as a sine wave.

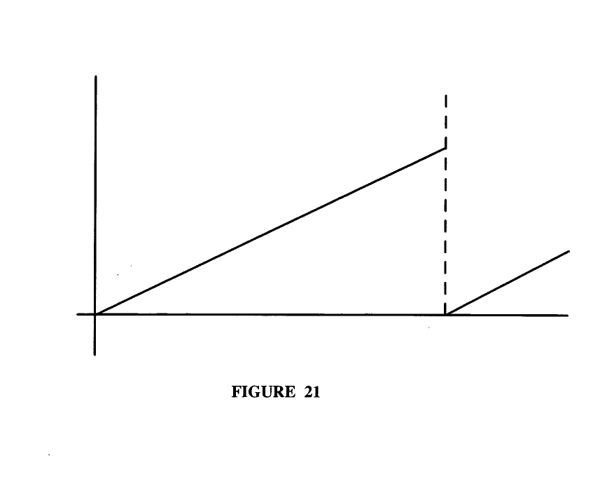

Another parameter of interest in the control of the rotating airfoils is referred to as yaw, which is the vertical projection down to the ground of the axis along the length of the airfoil. The yaw of each blade, or wing, will cycle from a 0 degree reference to a 360 degree reference, and then repeat, as seen in FIG. 21.

During stable flight at a given heading of the rotation envelope, and at a given inclination of the rotation envelope, the pitch of each blade at each moment can be determined. Also, the pitch of a blade can be altered, or controlled, using the control surface of the blade, which can be an elevator on a tail structure, or an attached elevator. Thus, based upon the calculation of desired pitch at a given moment in time, the control surfaces can be commanded to reach that desired pitch, which in turn will keep the rotation envelope at the desired heading and inclination.

The roll of the airfoil is defined as the angle of the blade along its length relative to the ground.

The desired pitch of an airfoil at a given point during the rotation of the airfoil can be stated as follows:

Desired pitch=i cos(yaw+ø)

Desired roll=i sin(yaw+ø)

In some embodiments, in order to determine the instantaneous yaw of an airfoil, a sensor, or sensor package, may be used to sense the three dimensional orientation of the rotor hub, or sensor packages may be placed on each airfoil. In the case where a sensor package which, when coupled with the appropriate electronics, can determine the spatial orientation of the airfoil, such as the pitch of the airfoil as well as the yaw of the airfoil, deviation from the sensed spatial orientation, such as deviation of the sensed pitch from the desired pitch for the pre-selected inclination angle can be controlled in real time with the elevator control surface of the airfoil. Thus, a control system which can control the elevator control surfaces of the airfoils based upon spacial orientation data from the airfoils can be used to keep the rotation envelope at the selected heading and inclination angle.

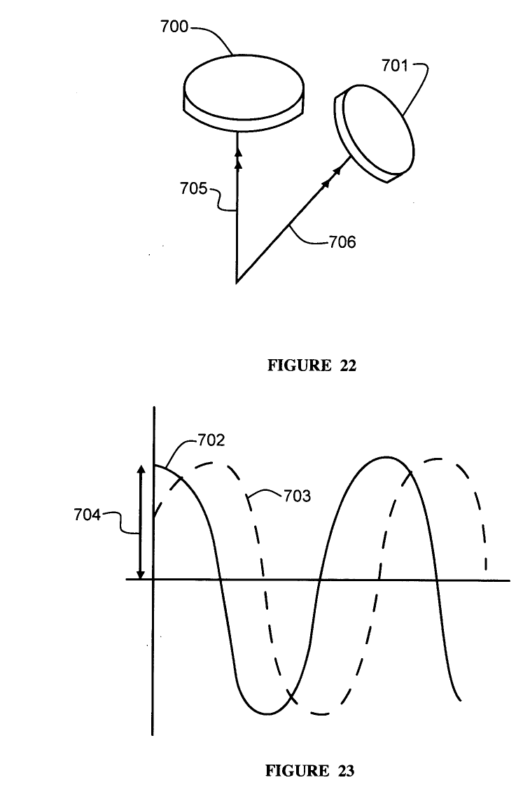

FIGS. 22 and 23 illustrate a first rotation envelope 700 at a first heading 705 and a second rotation envelope 701 at a second heading 706. The desired pitch curve 702 for the first heading 705 is shown for the preset inclination 704. The second heading 706 can be maintained using a phase shift on the pitch curve resulting in the second heading pitch curve 703. Thus, for a selected heading and inclination, the preferred spacial orientation of the airfoils can be determined, and in some embodiments, by the control system.

In some embodiments of the present invention, the control system is a closed loop control system for the elevator control of the airfoils. The sensor package on each airfoil, or rigidly coupled to the base of each airfoil, may be part of a control system electronics which includes processing capability to sense the actual pitch and roll of the airfoil and contrast it to the desired pitch and roll based upon the measured yaw at that moment to determine attitude error. Pitch correction may be achieved in real time via a command to the elevator control mechanism for the elevator control of the airfoil. The instantaneous attitude and position of the system, including inclination and heading may be relayed from the control system electronics via wireless communication to the ground, or via a connection along the tether of the system. The control system may have an onboard storage capability to track attitude errors as a function of yaw or as a function of time. The pitch and roll errors may be defined as the difference between the actual pitch and roll from the desired pitch and roll for a given yaw.

A desired change in heading results in a phase shift in the pitch curve, as discussed above. In some embodiments, a command to change heading may result in an instantaneous shift in the desired pitch of each airfoil, with corresponding commands to the control surfaces of the airfoil. In some embodiments, the command to change heading may result in a gradual change of the desired pitch curve of each airfoil over one or more revolutions of the system. In solely wind driven flight scenarios, generally the heading will be within some range of directly downwind. The control system may change the heading or inclination angles relative to the wind in order to increase or decrease the amount of air flowing through the rotational disc, and thus the rotational drive generated by the system. Additionally, the control system may simultaneously vary the drag generated by the generators and collective pitch of the airfoils in order to maintain optimal rotational speed, maximize power output, maintain airborne status, or avoid overloading the system. In powered flight scenarios, the heading may be any direction.

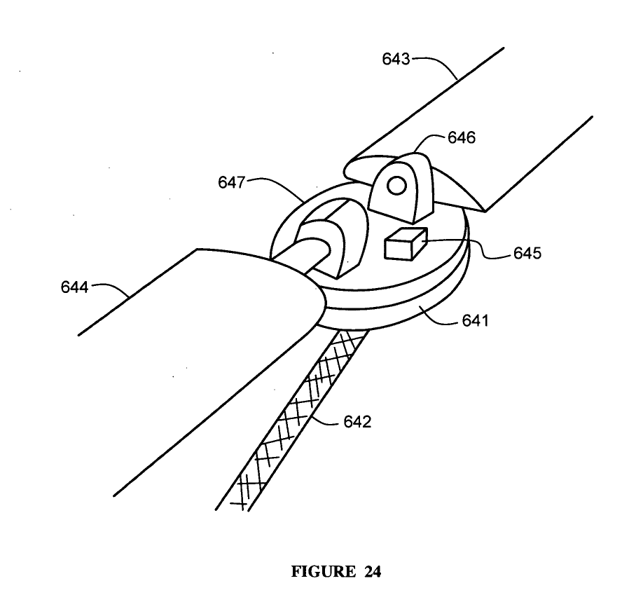

In some embodiments of the present invention, as seen in FIG. 24, a tether 642 is attached to a first portion 641 of a central hub. A second portion 640 of the central hub is structurally attached to the first portion 641 of the rotor hub, although it is free to rotate. The airfoils 643, 644 are attached to the second portion of the central hub at attach points 646, 647. In some embodiments, the airfoils are adapted to freely rotate within a given range and the pitch of the airfoil during flight is controlled using control surfaces on the airfoil. In some embodiments, the pitch of the airfoils is controlled with control mechanisms at or near the attach points.

In some embodiments, the control system 645 for the flying system is mounted on the second portion 640 of the rotor hub. In such embodiments, the pitch of each airfoil is determined utilizing angle information of the airfoil relative to the second portion of the rotor hub. In some embodiments, each airfoil will have a sensor package mounted to it. In some embodiments, each airfoil will have a sensor package mounted to it and will also have a separate control system portion adapted to control the pitch of that airfoil.

Another aspect that may be controlled is referred to as collective. The pitch of the blade, as described above and seen for example in FIG. 23, may be adjusted such that the cyclical variation is maintained but the overall magnitude is adjusted up or down. For example, if the pitch, and corresponding lift, of both airfoils in a two airfoil system is increased at all times by the same amount, this increase in collective would result in a pitch curve which is raised up in the graph as seen in FIG. 23. The pitch curves of both airfoils in a two airfoil system would both be similarly adjusted.

In some embodiments of the present invention, as seen in FIG. 24, a two airfoil controlled flying system is attached to a tether 642. A rotor hub 641 is attached to the tether 642. The rotor hub is adapted to have an outboard portion which rotates relative to the inboard portion attached to the tether. A first airfoil 643 is seen attached to the rotor hub at a first attachment 646. A second airfoil 644 is seen attached to the rotor hub at a second attachment 647. Although the airfoils 643, 644 are seen somewhat as wings which have their bases adjacent to the rotor hub, the airfoils can also be removed at a radial distance from the rotor hub and attached to the rotor hub with spars.

In some embodiments, the control system electronics and sensor package 645 reside on the rotor hub. Angular sensors may sense the rotation of each airfoil relative to the rotor hub, thus providing information about each airfoil. In some embodiments, a sensor package may be directly mounted to the airfoil or spar attached to the airfoil. In the case of a two airfoil system, there may be two sensor packages, one mounted to each airfoil or the spar attached to each airfoil.

The sensors package may be adapted to provide complete three dimensional positional information of the airfoil. In some embodiments, the sensor package may include magnetometers, gyros, and accelerometers.

In one example of a controlled flying system, the rotating portion of the system consists of two wings with a rotation diameter of approximately 22 feet. Each airfoil is a wing with a span of 90 inches, with an 8 inch chord. The wings have a foam core with a carbon fiber composite skin. The wings are rigidly attached to spars of 42 inch length approximately 2.5 inches back from the leading edge of the wings. The spars are CFC tubes with an outside diameter of 0.825 inches, and a wall thickness of 0.080 inches.

The spars connect to a rotor hub assembly approximately 4 inches by 14 inches by 3.5 inches in size, weighing about 7 pounds. Each spar is connected to the rotor hub using two ball bearing assemblies spaced approximately 4 inches apart. The rotor hub attaches to the tether with a gimbal and ball bearings, with power transfer across the rotor hub via a slip ring.

The wings are controlled using full flying elevators at the end of a 2 foot tail boom on the fuselage, mounted at the outer airfoil tips. Brushless electric motors are mounted on the front of the fuselages, using 15×10 inch propellers. The motors have 250 kV windings, approximately 2 KW capacity each. The power for the motors in powered flight comes from the ground and via the tether at 50V.

In another example of a controlled flying system, the rotating portion of the system consists of two wings with a rotation diameter of approximately 37 feet 8 inches. Each airfoil is a wing with a span of 90 inches, with an 8 inch chord. The wings have a foam core with a carbon fiber composite skin. The wings are rigidly attached to spars of 136 inch length approximately 2.5 inches back from the leading edge of the wings. The spars are CFC tubes with an outside diameter of 0.945 inches, and a wall thickness of approximately 0.1 inches.

The spars connect to a rotor hub assembly approximately 6 inches by 28 inches by 3 inches in size, weighing about 8 pounds. Each spar is connected to the rotor hub using two ball bearing assemblies spaced approximately 10 inches apart. The rotor hub attaches to the tether with a three axis gimbal, with power transfer across the rotor hub via a slip ring.

The wings are controlled using full flying elevators at the end of a 2 foot tail boom on the fuselage, mounted at the outer airfoil tips. Brushless electric motors are mounted on the front of the fuselages, using 15×10 inch propellers. The motors have 250 kV windings, approximately 2 KW capacity each. The power for the motors in powered flight comes from the ground and via the tether at 50V.

In both of the examples described above, each airfoil has a full flying elevator controlled by hobby servos. Each airfoil has an altitude and heading reference system (AHRS) sensor package mounted at or near the root of each spar, providing filtered three dimensional attitude and heading information. In some embodiments, the sensor package has three 1200 deg/sec MEMS gyros, three +/−5 g accelerometers, three axis magnetometer, and temperature compensation. The attitude and heading information may be filtered using a Kalman filter. The control system includes an ARM7 control board reading attitude information and driving elevator servo commands. Ground control includes a 900 MHz 2 way RF modem link to a ground station.

The control system is adapted to allow the flying system to engage in autonomous flight. Some of the parameters regarding the flight may be set from the ground station. Other aspects of the flight are contained within the flying portion of the control system. The autonomous flight is controlled by customized Paparazzi (an open source navigation package) software running on an onboard ARM7 computer. The main control loop runs at 120 Hz. The basic flight parameters (inclination, heading, collective) are set from the ground station. The PID tuning parameters (proportional gain, derivative gain, integral gain) are also set from the ground station.

A summary of the control of each blade is as follows. For each blade, during each cycle, the actual yaw and the actual pitch of the blade are measured. The actual pitch is compared to desired pitch, which was described above as: Desired pitch=i cos(yaw+ø). The pitch error is then calculated as the difference between the actual pitch and the desired pitch. The derivative of the pitch error is then calculated. The derivative of the pitch error is defined as the difference between the current cycle pitch error and the previous cycle pitch error. The integral of the error is calculated. The integral of the pitch error may start at zero. Using these factors, the elevator control of each wing is commanded using the following equation: Elevator command=(proportional gain×pitch error)+(derivative gain×derivative of pitch error)+(integral gain×integral of pitch error).

Although described using elevator control to fly a wing in the desired path, in some embodiments the wing may have its angle of attack altered using mechanical drive at the rotor hub.

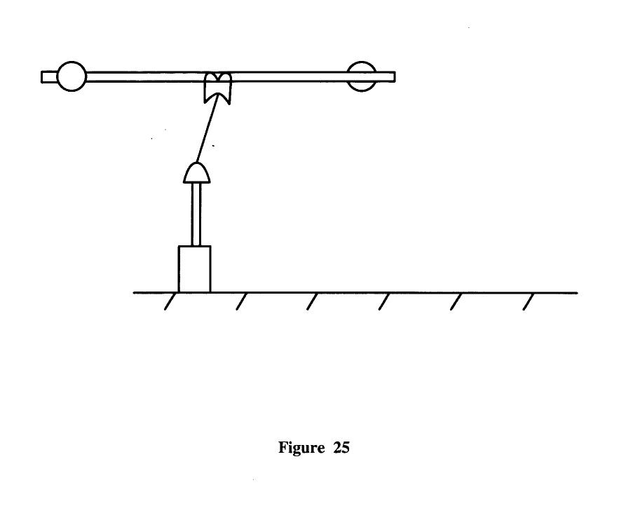

In some embodiments of the present invention, as seen in FIG. 25, the flying system may be adapted to have the flying portion dock onto a ground tower. The ground tower may be adapted to mate with the flying portion such that the tether is extended or retracted through the ground portion of the mating interface. The ground portion may be adapted to support the flying portion such that the airfoils are suspended above the ground when the flying portion resides docked onto the ground portion.

For the purposes of this application, a radial link is deemed to be substantially flexible when using cables or flexible tethers, which are not adapted to support the airfoil in a cantilevered fashion. A radial link is deemed to be substantially rigid when the link is adapted to support the link and the airfoil in a cantilevered fashion, as when the main hub is supported or captured. Although a substantially rigid link may of course have deformation, it nonetheless is adapted to support the link and airfoil.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. An auto-rotating flying system, said system comprising:
a main tether;
a base unit, said base unit coupled to a first end of said main tether;
a central hub, said central hub comprising a first portion and a second portion, said second portion adapted to rotate relative to said first portion, said first portion coupled to a second end of said main tether;
a plurality of lift sections; and
a plurality of radial links, each of said plurality of radial links coupled to the second portion of said central hub at a first end and coupled to one of said plurality of lift sections at a second end, wherein said lift sections are adapted to rotate in a substantially circular path around said central hub; and
a control system for controlling said flying system.

2. The system of claim 1 wherein said radial links are substantially rigid links.

3. The system of claim 2 wherein said lift sections comprise airfoils.

4. The flying system of claim 3 wherein said control system comprises:
sensors; and
control electronics adapted to determine spacial orientation of at least part of said flying system based upon input from said sensors.

5. The flying system of claim 4 wherein said airfoils are adapted to rotate along their long axis relative to said rotor hub.

6. The flying system of claim 5 wherein each of said airfoils comprise a control surface, said control surface adapted to give elevation control to said airfoils.

7. The flying system of claim 6 wherein said airfoils are adapted to fly in a circular flight path around said rotor hub, and wherein said circular flight path is substantially planar.

8. The flying system of claim 7 wherein said control system includes capability for controlling said control surfaces of said airfoils such that said airfoils fly in a predetermined circular flight path.

9. The flying system of claim 8 wherein said predetermined circular flight path is defined at least in part by the inclination of said circular flight path relative to ground.

10. The flying system of claim 9 wherein said predetermined circular flight path is defined at least in part by the heading of said circular flight path.

11. The flying system of claim 9 wherein said sensors determine the spacial orientation of each of said airfoils.

12. The flying system of claim 11 wherein each of said airfoils is attached to a sensor package adapted to provide sufficient information to determine spacial orientation of that airfoil.

13. The flying system of claim 12 wherein each of the sensor packages attached to each airfoil is attached to a separate control electronics portion adapted to control the pitch of that airfoil.

14. The flying system of claim 4 wherein said airfoils are adapted to fixedly rotate along their long axis relative to said second portion of said rotor hub.

15. The flying system of claim 14 wherein each of said airfoils comprise a control mechanism, said control mechanism adapted to rotate the airfoil along the long axis of the airfoil.

16. The flying system of claim 15 wherein said airfoils are adapted to fly in a circular flight path around said rotor hub, and wherein said circular flight path is substantially planar.

17. The flying system of claim 16 wherein said control system includes capability for controlling said control surfaces of said airfoils such that said airfoils fly in a predetermined circular flight path.

18. The flying system of claim 17 wherein said predetermined circular flight path is defined at least in part by the inclination of said circular flight path relative to ground and by the heading of said circular flight path.

19. The flying system of claim 18 wherein said sensors determine the spacial orientation of each of said airfoils.

20. A flying system, said system comprising:
a flexible main tether;
a base unit, said base unit coupled to a first end of said main tether;
a central hub, said central hub comprising a first portion and a second portion, said second portion adapted to rotate relative to said first portion, said first portion coupled to a second end of said main tether;
one or more airfoils, each of said one or more airfoils coupled to the second portion of said central hub at a first end, said airfoils adapted to fly in a substantially circular path around said central hub;
a control system for controlling said flying system; and
one or more sensors coupled to a portion of the system which rotates relative to said first portion of said rotor hub.

21. The flying system of claim 20 wherein said control system comprises control electronics adapted to determine spacial orientation of at least part of said flying system based upon input from said sensors.

22. The flying system of claim 21 wherein said one or more airfoils are adapted to rotate along their long axis relative to said rotor hub.

23. The flying system of claim 22 wherein each of said airfoils comprise a control surface, said control surface adapted to give elevation control to said airfoils.

24. The flying system of claim 21 wherein said control system is adapted to control said airfoils by adjusting the airfoil profile.

25. The flying system of claim 21 wherein said control system is adapted to control said airfoils by mechanically rotating said one or more airfoils along an axis along their length.

26. The flying system of claim 21 wherein said sensors are adapted to determine the spacial orientation of each of said airfoils as they fly in a substantially circular path around said central hub, and wherein said control system is adapted to control the airfoils as they fly in said substantially circular path.

27. The flying system of claim 26 wherein said control system determines preferred spacial orientation of each airfoil for positions along their substantially circular flight paths.

28. The flying system of claim 27 wherein said control system senses the spacial orientation of each airfoil at positions along their substantially circular paths.

29. The flying system of claim 28 wherein said control system controls the flight path of the airfoils based upon the deviation of the sensed spacial orientation of the airfoils from the preferred orientation of the airfoils.

30. The flying system of claim 26 wherein said control system controls the flight path of the airfoils based upon the preferred spacial orientation of the airfoils.
